(19) United States
(12) Patent Application Publication
(10) Pub. No.: US 2024/0351093 A1
(43) Pub. Date: Oct. 24, 2024

(54) MOBILE CABLE CONNECTION MODULE AND ARRANGEMENT FOR ASSEMBLING CABLES, AND METHOD FOR CONNECTING A CABLE TO SUCH AN ARRANGEMENT

(71) Applicant: Komax Holding AG, Dierikon (CH)

(72) Inventors: Alois Conte, Ebikon (CH); Stefan Viviroli, Horw (CH)

(21) Appl. No.: 18/633,601

(22) Filed: Apr. 12, 2024

(30) Foreign Application Priority Data
Apr. 19, 2023 (EP) 23168643.7

(51) Int. Cl. B21F 23/00; B21F 1/02; B21F 15/06

(52) U.S. Cl. CPC B21F 23/007; B21F 1/02; B21F 15/06

(57) ABSTRACT

An arrangement for assembling cables includes a cable processing machine, the machine having at least one and preferably a plurality of processing stations, and a mobile cable connection module. The cable connection module has a holding device by which the cable connection module can hold a cable to be processed, and the cable connection module is adapted to be connected, together with the cable, to the cable processing machine of the arrangement.

### FIELD

The invention relates to a mobile cable connection module, an arrangement for assembling cables, and a method for connecting a cable to an arrangement for assembling cables.

### BACKGROUND

An arrangement for assembling cables has become known, for example, from EP 1 447 888 A1. The arrangement substantially consists of a cable processing machine comprising a plurality of processing stations. During the assembly of cables in the cable processing machine, cables are, for example, cut to length and stripped, and then the cable ends can be crimped and optionally provided with sleeves and equipped with plug housings. “Crimping” is understood to mean the production of a non-detachable electrical and mechanical connection (crimp connection) by plastic deformation between a conductor and a crimp contact. The cable processing machine according to EP 1 447 888 A1 comprises a cutting and stripping unit and two processing stations having crimping presses. The cable processing machine also has a conveying unit, designed as a belt drive, for moving the cable along a longitudinal axis. The cutting and stripping unit is arranged on the longitudinal axis. However, since the two crimping press stations are located next to the longitudinal axis, the cable must be guided to the corresponding crimping presses by means of feed units, which are designed as swivel arms provided with grippers. The first crimping press is used to crimp the leading cable end, and the second crimping press is used to equip the trailing cable end with crimp contacts. The cables, such as insulated strands or solid conductors made of copper or steel, which are processed on the cable processing machine, are usually provided in bundles, for example in the form of drums or rollers, and guided using a cable conveying device to the processing stations of the cable processing machine. Since the cables originating from drums, cable rollers or cable bundles are more or less strongly curved and have a twist, it may be necessary to straighten the cables. Straight cables are important in order to be able to reliably carry out the process steps provided on the arrangement or with the cable processing machine, such as stripping and crimping. In order to straighten the cables as far as possible, these are pulled through a straightening device by means of the conveying unit. A straightening device of this kind has become known, for example, from EP 2 399 856 A1. The straightening device has rows of rollers opposite one another; the cable to be straightened is guided through between the rollers of the two rows of rollers.

If the cable supply, for example a cable spool, a cable barrel, or another bundle, comes to an end, a new cable must be removed from a new bundle and fed to the cable processing machine. Depending on the production task, other cable material is required, which is prepared on the cable processing machine. For cable assembly, it may be necessary, for example, to process other cables, for example cables of another color. Before the second cable can be used, the first cable must be previously removed from the cable processing machine. For this purpose, the cable conveying device is brought into a special operating mode in which the cable transport, with the conveying unit, takes place in reverse, and the cable is moved in the opposite direction until the cable leaves the cable conveying device. This process step is known to a person skilled in the art under the designation “unthreading”. After the unthreading, the new cable can be used. In practice, it has been found that the handling of the cable during a cable change can be difficult—in particular the unthreading and threading is demanding. For a new cable, the cable must be threaded manually through one or more straightening apparatuses of the cable processing machine. The cable tip is then inserted manually or automatically into the conveying unit, which then automatically draws in the cable, as a result of which the cable can be connected to the cable processing machine. A disadvantage of the solution described is that the threading of the cable on the cable processing machine is time-consuming and error-prone and has to be repeated every time, even if an earlier cable is to be used again. In addition, depending on the cable material, different straightening and guide devices are required, so that, under certain circumstances, a plurality of different devices, such as straightening apparatuses, having different roller configurations, have to be mounted on the cable processing machine, or the cable processing machine must be reconstructed depending on the cable material. Furthermore, it can be the case that the cable can form an undesired loop during unthreading from the cable processing machine. This loop can form between the conveying unit and the straightening apparatus, because the cable start has to be transported back from the separating knife to the cutting and stripping unit, up to before the conveying unit, and cannot easily be pushed through the straightening apparatus. The loop can ultimately hang into other machine parts and lead to malfunctions.

### SUMMARY

It is an object of the present invention to avoid the disadvantages of what is known and in particular to improve the handling of a cable during a cable change.

According to the invention, this object is achieved by a mobile cable connection module having the features described below. The mobile cable connection module for an arrangement comprising a cable processing machine for assembling cables comprises a retaining device, by means of which the cable connection module can be attached to the cable, for an at least temporarily rigid connection between the cable connection module and cable, for creating a mobile, easily manageable unit, which can be grasped manually or, for example, by a robot or another transfer device, and can be brought to the cable processing machine. In this case, the cable connection module is designed in such a way that it can be connected, together with the cable, to the cable processing machine of the arrangement. The cable connection module can thus be attached to a cable and is fixed to the cable for connecting to the cable processing machine. In order to retain the cable, the cable connection module can be equipped with clamping retaining means for forming the retaining device. However, the fixed connection between the cable connection module and cable is only a temporary connection, in particular for the time period until the cable connection module is connected, together with the cable, to the cable processing machine. Once the cable connection module, connected to the cable processing machine, is mounted on or connected to the machine, it is part of the cable processing machine. In the working position, when the cable assembly takes place, the holding action by the retaining device is removed and the cable runs through the cable connection module, it being possible, in the process, for it to undergo a cable pretreatment, such as a straightening process. The handling of the cable during a cable change can be significantly improved thanks to the cable connection module.

The cable connection module is obviously a compact and comparatively small and lightweight unit, and therefore it is particularly convenient and mobile. Thanks to the advantageous mobility, the cable connection module can be carried by a person easily and without great effort in their hands, at best even in just one hand, and can be brought to the desired location. The weight of the cable connection module can be less than 2 kg, preferably less than 1 kg, and preferably less than 500 g. The outer dimensions are around 30 cm×20 cm×10 cm, preferably 25 cm×10 cm×3 cm, or less.

The start of the cable of the cable bundle can be inserted by an operator into the cable connection module at any location when the retaining device is open. The retaining device can be closed or is closed after the insertion; the cable connection module and cable are now connected to one another in a more or less fixed manner. The cable receiving module can then be deposited, for example, on or in the vicinity of the bundle.

The retaining device preferably has one or more releasable retaining means, such as retaining jaws, which fix or inhibit the cable so that the cable tip does not unintentionally leave its position. Since the retaining device surrounds the start of the cable, it simultaneously protects the start of the cable against deformations, which could take place during handling or transporting of the cable-receiving module and would make the transfer to the cable processing machine more difficult.

According to one embodiment, the retaining device can comprise at least two opposing retaining jaws for retaining the cable in a clamped manner, preferably at least one of the retaining jaws being spring-loaded for applying the clamping force. Thanks to the spring, a sufficiently strong clamping of the cable results, in order to create the desired clamping force. If the cable connection module has a front or rear end, predetermined by the longitudinal cable direction, then for reliable fixing of the cable in each case two opposing retaining jaws can be arranged on one side, and particularly preferably both in the region of the front side and in the region of the opposite rear side (i.e. the side of the rear end). Preferably again, two opposing retaining jaws can be arranged on each of the mentioned two sides of the cable connection module. Thus, quasi a double retaining jaw arrangement results per side. The front side and rear side mentioned here relate in this case to the longitudinal central axis x, which at the same time corresponds to the cable longitudinal axis; when connected this then also corresponds to the machine longitudinal axis. In this case, front means facing the cable processing machine with the processing stations, or the direction in which the free end of the cable is pointing; the rear side is correspondingly the side remote from the cable machine or the opposite direction to the side with the free end of the cable.

An advantageous embodiment results when a cable-straightening unit is integrated into the cable connection module. As a result, no straightening apparatus must be mounted on the cable processing machine, or the cable processing machine must be reconstructed depending on the cable material. The straightening function is thus not performed by a machine-side device but by an external mobile unit that can, however, be docked onto the cable processing machine.

Preferably, the cable connection module can have two roller groups for straightening the cable and for forming the cable straightening unit, each roller group in each case comprising one, and preferably a plurality of, straightening rollers, the cable being able to be guided alternately between the straightening rollers of the two roller groups in each case, in a transport direction. The mentioned transport direction, when the cable connection module is connected, generally corresponds to the machine longitudinal axis. Using a delivery device, the first roller group can be displaceable in a closing direction, against the second roller group (delivery movement). In this case, the delivery device can be associated with the cable processing machine. However, it is also conceivable to integrate the delivery device in the cable connection module so that the cable straightening unit could be operated autonomously to a certain extent.

One of the roller groups is firstly displaced, starting from an open position, in a closing direction that extends at right angles to the transport direction of the cable, against the opposite roller group, into a closed position. In this closed position, the straightening rollers of the two roller groups, which extend in parallel with one another, are on the cable and touch it. This process is also known and familiar to a person skilled in the art under the designation “delivery”. In this case, the distance between the rollers can be set manually. Alternatively, the roller spacing can also be set automatically.

The cable straightening unit of the cable connection module can comprise two roller supports for the two roller groups, on which roller supports the respective straightening rollers of the respective roller group are fastened so as to be freely rotatable. Furthermore, a cable module frame for carrying the two roller supports can be provided, preferably only one of the roller supports being mounted in the cable module frame so as to be displaceable in a closing direction. The cable connection module is or can be detachably connected to the cable processing machine via at least one of the roller supports and/or via the cable module frame.

For example, on the one hand, one of the roller supports can be provided with connection means, and on the other hand, the cable module frame can be provided with connection means for connection to the cable processing machine. However, it is also conceivable for the cable connection module to be detachably connected or connectable to the cable processing machine via the cable module frame. A particularly optimal connection results when the cable connection module is or can be detachably connected to the cable processing machine via the roller supports of the cable straightening unit. In order to connect the cable connection module to the cable processing machine, the connection means can consequently be provided in the roller supports. Connection means can be openings, for example, via which openings the cable connection module can be inserted into corresponding receiving mandrels of the cable processing machine. A reverse connection solution, i.e. openings in the cable processing machine and receiving mandrels in the cable connection module, is of course also conceivable.

The cable receiving module with the retaining device can fix or inhibit the cable so that the cable tip does not unintentionally leave its position. Thus, the cable is advantageously retained in the cable-receiving module and can remain stretched. The stretched position of the cable contributes to the cable coming to rest between the straightening rollers in a defined manner when the roller supports are moved together or during delivery, and not evading the straightening roller.

An alternative embodiment relates to a cable straightening unit having two roller supports for the two roller groups, in which the respective straightening rollers of the respective roller group are loosely held (that is to say, are not fastened fixedly by a bearing for specifying the rotatability in the support). The freely rotatable mounting of the straightening rollers results from the fact that, for example, shaft elements can be inserted into bearing bushes of the straightening rollers from the outside (i.e. from the machine), and the bearing is thus created for the straightening rollers that are now freely rotatable about the shaft elements.

Furthermore, it can be advantageous, in particular with regard to the efficiency, if the cable connection module is designed such that, after the cable connection module is connected to the cable processing machine of the arrangement, the retaining device, for example with the at least two opposing retaining jaws, is in operative connection with the cable straightening unit in such a way that, when the cable straightening unit is delivered, the clamping action on the cable by the retaining jaws or other means of the retaining device is or can be lifted.

The cable connection module can be equipped with a blocking element, for example in the form of a blocking lug, which prevents, for the transport of the cable connection module, the roller supports from being able to be unintentionally pressed together.

The roller supports can be operatively connected to one another by means of a spring arrangement comprising, for example, one or preferably two helical compression springs for generating a preload force for the cable straightening unit in an open position. For straightening the cable, the roller supports are moved toward one another in a delivery movement. The relative movement, which leads to the distance between the roller supports being reduced, is referred to as delivery or closing of the cable control unit.

Instead of helical compression springs, however, other solutions for generating the preload force in the open position between the roller supports are also conceivable. According to an alternative embodiment, the roller supports of the cable control unit can be connected to one another via a spring assembly and formed in one piece, the spring assembly preferably being designed to be flat and being able to be produced together with the roller supports from a common metal sheet. The spring assembly can be produced by a lasered steel sheet. The spring assembly can have a serpentine or meandering structure. The roller supports are thus formed by a common component, the required flexibility and mobility between the roller supports being achieved by the above spring arrangement in the form of the planar spring arrangement (also known as a flat spring). The mentioned variant comprising the roller supports, which are integrally connected to one another via a spring arrangement, could also be advantageous for conventional cable processing machines equipped with straightening apparatuses.

In order to facilitate the threading and/or unthreading process, drive rollers can be used, by means of which a forward and/or backward movement of the cable in the transport direction is enabled. Two drive rollers can be arranged opposite one another and form a drive roller pair.

For a pair of drive rollers of the cable processing machine, the cable connection module can have lateral roller insertion openings, which are arranged in a cable module frame, and via which, if necessary, the drive rollers can be retracted in the radial direction of the cable for establishing an operative connection for driving the cable forward and/or backward.

Particularly preferably, the roller insertion openings can, per side, preferably each be arranged between two retaining jaws.

In this case, the forward movement of the cable serves for threading, and the backward movement of the cable serves for unthreading.

The cable receiving module can contain a cable drive function, which moves the cable forward and backward along its axis or in the direction of the machine longitudinal axis. As a result, this would support the conveyor unit on the cable processing machine or could be dispensed with altogether. For example, this can be implemented by providing straightening rollers having dedicated motors, or by mechanically coupling the straightening rollers to drives of the cable processing machine. In this case, the mechanical or electrical energy can be transmitted via suitable interfaces (drive shafts, electrical contacts).

The cable connection module can further be designed such that it can be connected to a cable bundle before the connection, so that the cable connection module can be stored and transported together with the cable bundle. The cable receiving module can thus be deposited in the bundle. It can thus further be ensured that the cable receiving module remains fastened to the associated cable bundle until use, and thus the cable receiving module can remain together with the cable start, on the one hand, and the cable bundle, on the other hand, during storage and transport.

The cable connection module can be equipped with a machine-readable identifier so that a reader can recognize the exact type of cable before, during or after connection in order to ensure an optimal and traceable assembly process. This embodiment solves the disadvantage of the usual approach of conventional assembly arrangements, which is that the association of the cable bundle with the machine cannot be identified by machine, i.e. the machine cannot itself identify whether the correct cable material is clamped.

A further aspect of the invention relates to an arrangement for assembling cables, comprising a cable processing machine having at least one and preferably a plurality of processing stations and a supply unit comprising, for example, a cable gripper, for supplying a cable end of the cable to one of the processing stations. A series of advantages result from the fact that the cable processing machine has a fastening device via which a mobile cable connection module, in particular the cable connection module according to the preceding description, which holds a cable, can be or is detachably fastened to the cable processing machine in order to connect the cable. An improved or alternative arrangement compared to the prior art is provided, with which a cable change can be carried out efficiently and effectively in a cable processing machine. Thanks to the mobile multifunctional cable connection module, the cable processing machine can be designed in a simpler, safe, and cost-effective manner. The mobile cable connection module in particular simplifies the threading of the cable into the cable processing machine. Since the cable connection module remains on the cable even after a cable change, it can easily be used again if necessary, and the complex threading does not have to be repeated every time.

The arrangement for assembling cables can be a type of kit and thus consist of a cable processing machine having at least one and preferably a plurality of processing stations, and a mobile cable connection module for this arrangement, the cable connection module comprising a retaining device by means of which the cable connection module can be attached to a cable, and that the cable connection module is designed such that it can be or is connected, together with the cable, to a cable processing machine of the arrangement.

The cable processing machine can have a conveying unit upstream of the feed unit for transporting the cable to the feed unit. This conveying unit comprising, for example, conveying means movable in opposite directions, the cable being able to be conveyed between the conveying means by frictional connection, when at least one of the conveying means is driven, can for example be designed as a belt drive in a manner known per se.

The mobile cable receiving module can contain further processing devices, e.g. pinch rollers, dirt scrapers, or cable brakes. The cable receiving module can further contain quality monitors (e.g. splice monitoring or node detection). For this purpose, the cable receiving module can have suitable electrical or mechanical interfaces (for example, electrical or mechanical contact surfaces or electrical sockets). The cable receiving module can be connected via these interfaces to the cable processing machine or, for example, a set-up device.

Furthermore, the arrangement can comprise a cable pretreatment station having a cable straightening unit, the cable straightening unit being associated with the cable connection module and thereby being designed to be mobile. Consequently, the cable connection module can be connected to the cable straightening unit, together with the cable, to the cable processing machine. Thus, a complicated cable processing machine having different straightening and guide devices depending on the cable material is not required. A reconstruction as in a conventional cable processing machine during a cable change to a different material is also unnecessary.

In this case, the cable pretreatment station with the cable straightening unit can preferably be arranged upstream of the conveying unit.

The cable processing machine can have a connection platform for a plurality of cable connection modules for selective processing of a cable from one of the cable connection modules, the connection platform being movable by means of an adjusting mechanism in such a way that the cable connection modules can be adjusted between a working position and a parked position.

In a preferred embodiment, the connection platform can be mounted on a machine frame so as to be displaceable laterally or transversely and preferably at right angles to the machine longitudinal axis. Alternatively, it would also be conceivable to design the connection platform to be pivotable.

The cable processing machine can comprise drive rollers that are drivable by means of a drive, the drive rollers being designed to convey the cable clamped between two drive rollers. Furthermore, a roller moving device can be provided, by means of which the drive rollers can be moved relative to one another in order to apply a pressing force to the cable. In an open position, the drive rollers can be spaced so far apart from one another or otherwise positioned in such a way that the cable connection module can be arranged and fastened to the cable processing machine when connecting between the drive rollers, which are combined in pairs, and that the drive rollers can be moved from the open position into an active position and can be inserted into the cable connection module in such a way that they contact the cable, located in the cable connection module, in a clamping manner in the active position, and thus enable the cable conveying with regard to the threading and/or unthreading.

As a result of the arrangement according to the invention, and in particular thanks to the drive rollers, it is virtually impossible for the cable to form an undesired loop during the unthreading from the cable processing machine.

The cable processing machine can in each case comprise two drive rollers for forming a front and a rear drive roller pair, the drive rollers of the front drive roller pair serving to thread the cable into the cable processing machine, and the drive rollers of the rear drive roller pair being provided for unthreading the cable from the cable processing machine.

The drive rollers can be retracted into or via the already mentioned lateral roller insertion openings of the connected cable connection module, in order to establish an operative connection for driving the cable in a forward and/or backward direction.

The cable processing machine, in particular, if present, the connection platform of the cable processing machine, can have receiving mandrels for specifying a slot for a cable connection module in each case, on which receiving mandrels the cable connection module can be inserted into or placed onto the cable processing machine, for fastening or connecting, via openings corresponding to the mandrels. Instead of the mandrels and the openings, connecting means such as other positive connections are also conceivable. A frictional connection is also possible. The receiving mandrels can be designed to be movable, which makes it possible for the feed movement of the cable straightening unit to take place via the receiving mandrels, when the straightening unit is integrated in the cable connection module.

The arrangement can comprise a reading device, which is designed to detect data relating to a cable held by a cable connection module. In particular, the reading device, as a reader, can be designed to recognize the machine-readable identification of the cable connection module.

The invention further relates to a method for connecting a cable to an arrangement for assembling cables. In this case, the arrangement can contain at least one processing station and a feed unit, for example comprising a cable gripper, for feeding a cable end of the cable to at least one processing station.

This arrangement can preferably be the above-described arrangement. The method is characterized by the following steps:
attaching a mobile cable connection module to a cable in the region of the cable end,
transferring the cable end, together with the cable connection module attached thereto, for arranging and fastening the cable connection module to a cable processing machine of the arrangement, whereby the cable is connected.

The attachment can take place at any location, for example early on in the process at the cable supplier's facility. From this location, the step of transporting the cable, together with the cable connection module attached thereto, can be carried out before the transfer.

After the connection, the cable connection module is in a parked position or already in a working position.

In this case, the transfer preferably takes place manually or automatically using a robot or another transfer device.

It can be advantageous if the rotary cable gripper(s) of the cable alignment apparatus is/are moved in a vertical direction to create the offset. Alternatively, other directions of movement for moving the rotary cable grippers are also conceivable. For example, at least one of the rotary cable grippers can be displaced in a diagonal direction to create the offset.

It can be particularly advantageous if the cable is held in the cable connection module, for transport and transfer or until connection, in such a way that it projects out of the cable connection module. The threading of the cable can be simplified again in this way.

A particularly advantageous method results if, for transport and transfer, the cable is held in the cable connection module, which cable connection module comprises straightening rollers, in such a way that the cable is not acted upon by the straightening rollers, and that the cable is only acted upon by the straightening rollers of the cable connection module, for straightening the cable, after the connection.

### DESCRIPTION OF THE DRAWINGS

Further individual features and advantages of the invention can be derived from the following description of exemplary embodiments and from the drawings. In the drawings:

FIG. 1 a schematic illustration of an arrangement according to the invention for assembling cables, comprising a cable processing machine and a cable connection module connected thereto,

FIG. 2 shows a mobile cable connection module for connection to a cable processing machine of an arrangement for assembling cables, comprising a connection platform,

FIG. 3 shows a cable processing machine of an arrangement for assembling cables, comprising a connection platform,

FIG. 4 is a slightly smaller illustration of the cable processing machine from FIG. 3, a cable connection module being connected to the cable processing machine,

FIG. 5 shows the cable processing machine comprising two cable connection modules placed on the connection platform,

FIG. 6 shows the cable processing machine after a cable change, in which the connection platform has been displaced,

FIG. 7 shows a cable connection module connected to a cable processing machine, before a threading process,

FIG. 8 shows the cable connection module from FIG. 7 during threading,

FIG. 9 shows a cable connection module connected to a cable processing machine, before an unthreading operation,

FIG. 10 shows the cable connection module from FIG. 9 during the unthreading,

FIG. 11 is a plan view of a further mobile cable connection module,

FIG. 12 shows a cable processing machine of an arrangement for assembling cables, according to a further embodiment,

FIG. 13 shows the cable processing machine from FIG. 12 having a cable connection module connected thereto,

FIG. 14 shows a mobile cable connection module having a manually actuatable cable straightening unit in a closed position,

FIG. 15 shows an alternative mobile cable connection module having a cable straightening unit in an open position,

FIG. 16 shows the mobile cable connection module from FIG. 15 having the cable straightening unit in the closed position,

FIG. 17 is an enlarged cross-sectional view of a mobile cable connection module having an open retaining device,

FIG. 18 shows the mobile cable connection module from FIG. 17 with the closed retaining device,

FIG. 19 shows the mobile cable connection module from FIG. 17 comprising a release element that is partially retracted into the closed retaining device for releasing the clamping action on the cable by the retaining device,

FIG. 20 shows a variant of the mobile cable connection module shown in FIG. 17 comprising a closed retaining device and a roller support of the cable straightening unit that is blocked for transport,

FIG. 21 shows the mobile cable connection module from FIG. 20 comprising the cable straightening unit after a delivery process (cable straightening unit in the closed position),

FIG. 22 is a schematic view of a cable bundle with a cable connection module, which together form a mobile unit that can be connected to a cable processing machine,

FIG. 23 is a perspective view of a mobile cable connection module according to a further embodiment,

FIG. 24 is a perspective view of the mobile cable connection module from FIG. 23, but from a different viewing angle,

FIG. 25 is a perspective view of an alternative embodiment of a mobile cable connection module,

FIG. 26 is a cross-sectional view of the cable connection module from FIG. 25 having shaft elements inserted into bearing bushes of the straightening rollers,

FIG. 27 is a highly schematic view of an arrangement for assembling cables, comprising a cable processing machine and a mobile cable connection module, and

FIG. 28 shows an alternative embodiment of the arrangement of FIG. 27.

### DETAILED DESCRIPTION

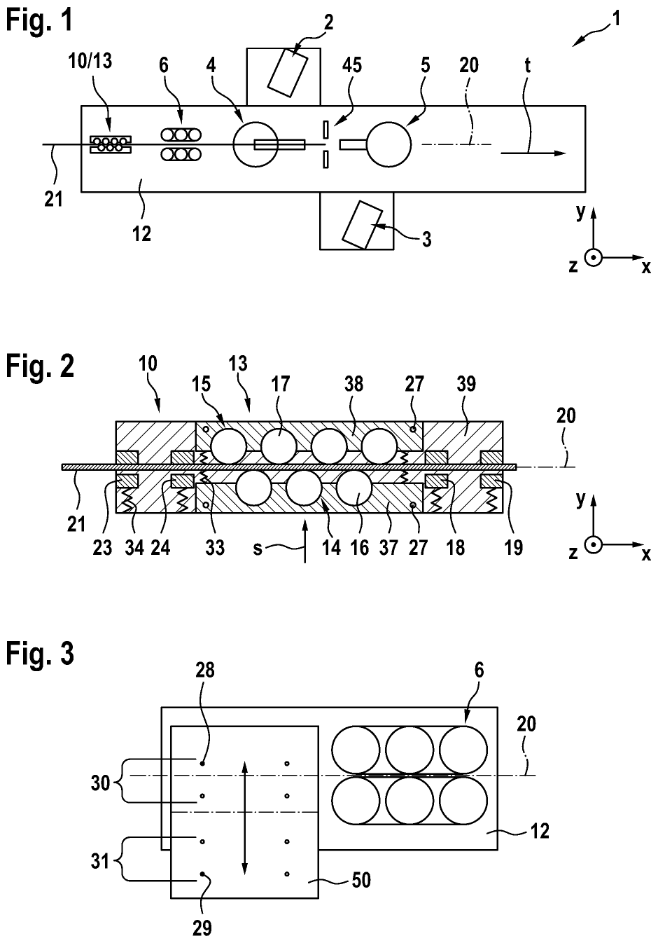

FIG. 1 shows an arrangement comprising a cable processing machine denoted by 1. The cable processing machine 1 comprises a conveyor unit 6 designed as a belt conveyor, which brings the cable 21 along the machine longitudinal axis 20, in the transport direction indicated by the arrow t, to the supply unit 4, which is designed as a pivoting unit. The cable is usually an electrical cable containing, for example, a solid conductor made of copper or steel, or stranded wire, and insulation as a sheath for the conductors. The pivoting unit 2, which is rotatable about a vertical axis, has a gripper for retaining the cable 21. As can be seen, a stripping station 45 for cutting to length and stripping the cables is arranged on the respective longitudinal machine axis 20. In contrast, the processing stations 2 and 3 are arranged next to the longitudinal machine axis 20. In FIG. 1, for the sake of simplicity in each case only one processing station is shown per side, but often the cable processing machine 1 has a plurality of processing stations per side. The processing stations 2, 3 can be sleeve stations and/or crimping stations. In this case, the crimping station can contain a crimping press for connecting a cable end to a crimp contact. The processing station(s) 2 are associated with the leading cable end; the processing station(s) 3 serve for assembly of the trailing cable ends. The supply or feed unit 4 serves the processing station(s) 2 and another supply or feed unit 5 serves the processing station(s) 3. With regard to the design and the mode of operation of a cable processing machine comprising crimping presses, reference is made by way of example to EP 1 341 269 A1. Additionally or alternatively, equipping stations for equipping cable ends with plug housings would also be conceivable as processing stations. Since the focus here is on processing the leading end of the cable, only the conveyor unit 6, possibly the feed unit 4 and possibly the processing station(s) 2 are referred to below.

The arrangement comprising the cable processing machine 1 further comprises a cable pretreatment station arranged upstream of the conveyor unit 6. In the present case, this cable pretreatment station substantially consists of a cable straightening unit 13, which can be removed from the cable processing machine 1. The cable straightening unit 13 is designed to be mobile, in the manner explained in detail below, and can be connected to the cable processing machine 1. This mobile unit is referred to below as the cable connection module 10 or cable receiving module. In the present case, as already mentioned, the cable connection module 10 has a cable straightening unit 13. For certain applications, for example when cables are used that are sufficiently straight or are provided having already been pretreated, mobile cable connection modules 10 without a cable straightening unit are sometimes conceivable.

The Cartesian coordinate system shown in FIG. 1 and in the following figures, having the axes x-y-z, serves as an aid for understanding the directions and the main movements of the components of the arrangement for assembling cables comprising the cable processing machine 1 and the cable connection module 10.

FIG. 2 shows a mobile cable connection module 10, which can be connected to the cable processing machine 1. The cable connection module 10 comprises a retaining device, by means of which the cable connection module 10 can be attached to the cable 21. In the present embodiment, this retaining device comprises four pairs of retaining jaws, each pair having two opposing retaining jaws. It can be seen that the cable connection module has a front or rear end specified by the cable longitudinal direction or axis x. Each two opposing retaining jaws 18 and 19 are in each case arranged in the region of the front side; each two opposing retaining jaws 23, 24 are in each case arranged in the region of the front side. The two opposing retaining jaws 18, 19, 23, 24 serve to hold the cable 21 in a clamped manner, each one of the retaining jaws 18, 19, 23, 24 being spring-loaded for applying the clamping force. The corresponding springs, by way of example in the form of helical compression springs, are denoted by 34. The cable connection module 10 can be attached to the cable start of the cable 21 by means of the retaining device, and thus be brought to the cable processing machine. The retaining device comprising the retaining jaws 18, 19, 23, 24 enables an at least temporarily rigid connection between the cable connection module and the cable, for creating a mobile, easily manageable unit, which can be grasped manually or by a robot or another transfer device and can be brought to the cable processing machine 1.

The cable straightening unit 13, which forms an integral component of the cable connection module 10, for straightening the cable 21, has two roller groups, each roller group in each case having a plurality of straightening rollers 16, 17, the cable 21 being able to be guided alternately in each case between the straightening rollers 16, 17 of the two roller groups 14, 15, in a transport direction x. The cable straightening unit 13 has two roller supports 37, 38 for the two roller groups 14, 15, on which the respective straightening rollers 16, 17 of the respective roller group are fastened so as to be freely rotatable. The cable straightening unit 13 further has a cable module frame 39 for carrying the two roller supports 37, 38, one of the roller supports 37 being mounted in the cable module frame 39 so as to be displaceable in a closing direction indicated by the arrow s.

The straightening rollers 16, on the one hand, and the straightening rollers 17, on the other hand, run parallel to one another and are each located on horizontal roller lines. The cable 21, which can be guided through between the rollers 16 and the rollers 17, for straightening, likewise runs in the horizontal direction x. In an open position, the two roller groups 14, 15 are spaced apart from one another so far that a cable can be inserted or laid between the rollers 16 and rollers 17. The roller group is then moved, with the straightening rollers 16, against the opposite roller group. The closing direction s runs at right angles to the x-axis, i.e. in the direction of the y-axis. After completion of the delivery process, after the roller group 14 has been moved against the other roller group 15 in the closing direction, the cable 21, which is now acted upon alternately by the straightening rollers 16, 17, can be pulled in the transport direction by the straightening unit 13 of the connected cable connection module 10, by means of the conveying unit 6. The two roller groups are arranged side by side, at least when the cable connection module is connected, and in this case the closing direction runs on a horizontal plane.

The straightening rollers 16 of the first roller group 14 are fastened on a roller support, designated 37, so as to be freely rotatable. The straightening rollers 17 of the second roller group 15 are fastened to a second roller support 38 so as to be freely rotatable. The cable connection module 10 further comprises a module frame 39 in the form of a base plate for carrying the first roller support 37 and the second roller support 38. The roller supports 37, 38 are configured in a plate-like manner in the present case.

In addition to the displaceability, the roller support 37 for the first roller group 14 can additionally be mounted in the module frame 39 so as to be rotatable in relation to a vertical pivot axis running at a right angle to the transport direction (i.e. in the direction of the z-axis) (cf. for example FIG. 13 below). The basic structure of the straightening unit 13 is similar to the straightening apparatus known from EP 2 399 856 A1.

The roller support 37 is supported on the module frame 39 by spring elements 33 in the form of helical compression springs, which act on the roller support 37 with a spring force counter to the closing direction s.

In addition to the retaining device which holds the cable 21, and the straightening rollers 16, 17, the mobile cable connection or receiving module 10 can also comprise further devices (not shown here), which may be required or helpful for processing the cable material, such as pinch rollers, cleaning devices, guide parts, measuring and monitoring devices. In particular, it can comprise guide parts, which ensure trouble-free cable transport.

A special feature of the cable connection module 10 shown here is that the connection means for connecting the cable connection module 10 to the cable processing machine 1 are provided in the roller supports 37, 38. In the present case, the connection means are, by way of example, openings 27 via which the cable connection module 10 can be inserted into corresponding receiving mandrels of the cable processing machine 1. These receiving mandrels are visible in FIG. 3 and denoted there by 28 and 29.

FIG. 3 shows a part of a cable processing machine 1 for an arrangement for assembling cables. Of the cable processing machine 1, the machine frame 12 and the conveyor unit 6 arranged thereon for transporting the cable to the supply unit (not shown here) are visible. Like the cable processing machine explained with reference to FIG. 1, this cable processing machine 1 can also further comprise at least one or more processing stations. A connection platform 50 is provided on the cable processing machine 1, which platform is mounted laterally or at right angles to the machine longitudinal axis 20, i.e. in the y-direction, on the machine frame 12. The displaceability of the connection platform 50 is indicated by a double arrow.

In the present case, the connection platform 50 is designed as a platform for two cable connection modules for selective processing of a cable from one of the cable connection modules. The connection means are receiving mandrels 28 and 29 in this case. A first cable connection module can be placed on the four receiving mandrels 28. A first cable connection module can be placed on the four receiving mandrels 29. The groups of receiving mandrels 28, 29 thus form slots 30, 31 for cable connection modules.

If the cable processing machine 1 is to process the cable located on a specific cable receiving module 10, this cable receiving module 10 is brought to the cable processing machine 1, for example into a parked position. This can take place while the cable processing machine is in production using a previous cable.

In the present case, the conveying unit 13 running along the machine longitudinal axis 20 or in the x direction, for transporting the cable, is designed as a belt conveyor. The cable can be grasped and transported between the two belts. For this purpose, the conveying unit 13 further comprises conveying means that are designed as endless belts and are movable in opposite directions, the cable being able to be conveyed between the conveying means by frictional connection, when at least one of the conveying means is driven. The conveying unit 13 could in principle also be designed as a roller drive.

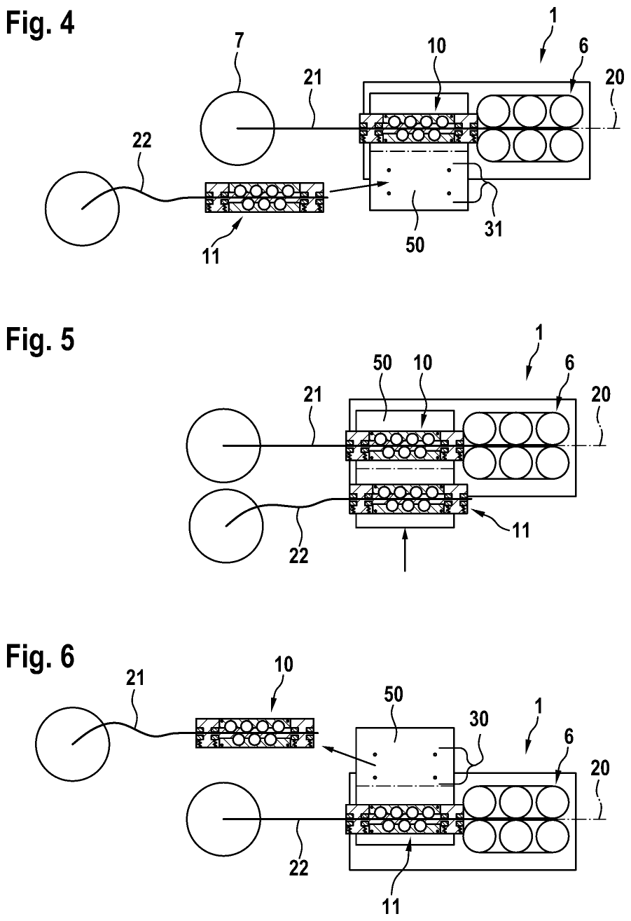

The mode of operation of the cable processing machine 1 comprising the connection platform 50 for the two cable connection modules for selective processing of a cable from one of the cable connection modules is evident with reference to FIGS. 4 to 5. The connection platform 50 can be moved by means of an adjusting mechanism in such a way that the cable connection modules are adjustable between a working position and a parked position. FIG. 4 shows a cable processing machine 1 with a mobile cable connection module 10 connected thereto. The cable connection module 10 is located in a working position, from which cables can be assembled in the cable processing machine 1. The second slot 31 specified on the connection platform 50 is located in a parked position and is free. With regard to a cable change, a second mobile cable connection module, denoted 11, (together with the cable 22 retained by it) can be placed on this slot 31. This configuration is shown in FIG. 5. This can take place while the cable processing machine 1 is still in production with a previous cable 21. Now, for example after the cable bundle 7 with the cable 21 is empty, or after an unthreading process has been performed at the cable connection module 10, the connection platform 50 is displaced so that the slot 31 with the cable connection module 1 connected there is in the working position. Thereafter, as shown in FIG. 6, the cable connection module 10 can be removed and taken away from the cable processing machine 1. A next cable connection module that holds a cable is not placed on the now free slot 30. The slot 30 is in the parked position.

The operator can communicate the attachment of the cable receiving module, in the parked position of the machine (FIG. 5), by actuating a button, or the cable processing machine 1 has suitable sensors for determining that a cable receiving module 11 is located at the parked position, which can advantageously be a necessary precondition for the subsequent change.

The cable processing machine 1 can have, for example, an RFID reader associated with the parked position, which detects the appearance of a cable receiving module 11 with a specific identity. The cable processing machine 1 can signal to the attaching operator, by feedback (e.g. colored luminaires), whether it is the expected cable receiving module, and block the subsequent change in the event of an error.

From the parked position, the cable receiving module 11 is brought into the working position before the following production begins, whereupon the cable processing machine can, if necessary, move the cable start from the cable receiving module into the conveying unit and start production with the new cable. The cable material can thus be changed in the machine without an operator being present.

In the illustrated example according to FIGS. 4 to 6, the parked and working positions are located on a connection platform 50, which is designed as a displaceable plate and has receptacles for a plurality of cable receiving modules. The working position is in each case that which is located in the machine longitudinal axis 20. The other positions are parked positions in which the cable receiving modules 10, 11 can be inserted or from which it can be removed while the machine is running.

A plurality of parked and working positions can be present on a cable processing machine 1. However, the cable receiving modules 10, 11 can also be moved in mutually independent movements between the parked position and the working position, for example by bringing them from two parked positions into the working position with a rotational movement.

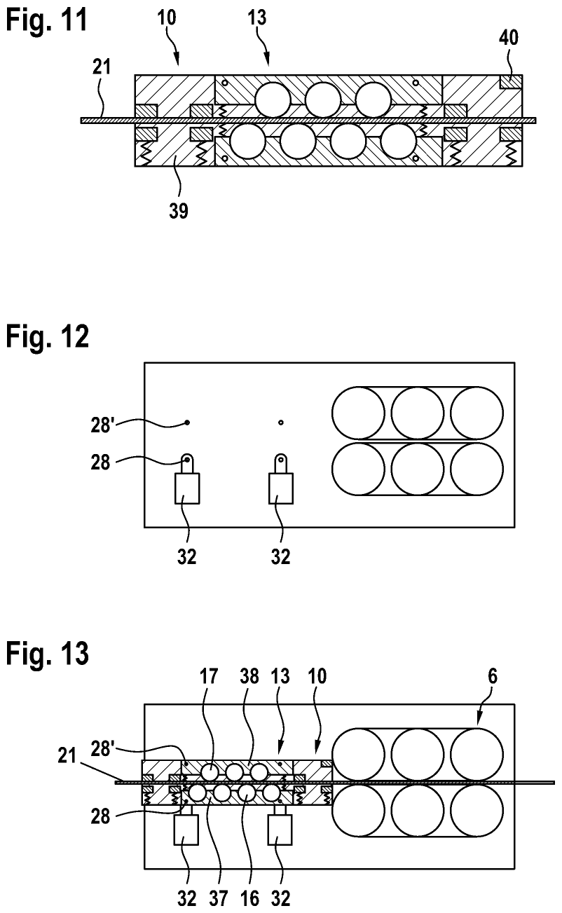

Instead of two slots, accordingly connection platforms 50 having three or even more slots can also be provided. Of course, cable processing machines 1 having only one single slot are also conceivable. This slot can preferably be adapted in the cable processing machine 1 in such a way that, after the cable connection module has been placed on or connected, this or the cable retained by it is aligned coaxially with the machine longitudinal axis 20 (cf. further FIGS. 12 and 13). Instead of bringing the cable receiving module 10 into a parked position, it can thus also be brought directly into the working position.

The movement of the cable receiving module 10 into the parked position or into the working position of the cable processing machine 1 can take place manually or, for example, using an automatic transfer system, such as a robot. In order to facilitate the latter, the cable receiving module 10 can be equipped with a mechanical interface, which allows automatic gripping.

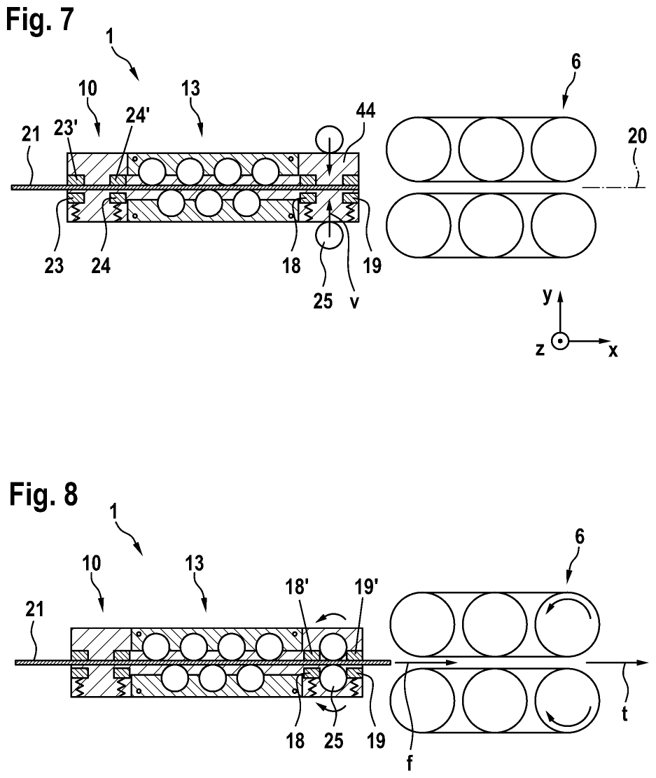

The cable processing machine 1 comprises two drive roller pairs. FIGS. 7 and 8 show a first drive roller pair. The cable processing machine 1 comprises front drive rollers 25 that can be driven by means of a drive, the drive rollers 25 being designed to convey the cable 21, clamped between two drive rollers 25, toward the conveying unit. With the aid of a roller displacement device, the two drive rollers 25 can be moved relative to one another in order to apply a pressing force to the cable 21. In the rest position shown in FIG. 7, the drive rollers 25 are spaced apart from one another so far that the cable connection module 10 can be arranged and fastened to the cable processing machine 1 during or after the connection between the drive rollers 25.

The two drive rollers 25 can be moved from the rest position into an active position and can be introduced into the cable connection module 10 in such a way that they contact the cable 21 located in the cable connection module 10 in a clamping manner in the active position. In this case, the drive rollers 25 are movable at right angles to the machine longitudinal axis 20. This movement of the drive rollers 25 is indicated in FIG. 7 by two arrows v. As soon as the drive rollers 25 are in the active position, they can be set in rotation by means of a drive and thus convey the cable 21 forward in the f direction. This is shown in FIG. 8. The cable start of the cable 21 thus reaches as far as and into the conveying unit 6, and the cable can be threaded in this way. Finally, the cable start can be conveyed further in the t direction by means of the conveying unit 6, whereupon the threading process is completed. The drive rollers 25 can now be returned to the rest position. As a rule, the drive rollers 25 remain in the rest position during normal operation, i.e. the operating phase in which cables are assembled on a large scale.

For a pair of drive rollers 25, the cable connection module 10 has lateral roller insertion openings 44, via which the drive rollers 25 can be retracted at right angles to the machine longitudinal axis 20 or in the radial direction of the cable for establishing the operative connection for driving the cable 21 forwards. The roller insertion openings 44 are evidently arranged in the region of the front side of the cable connection module 10. As can be seen for example from FIG. 8, the drive rollers 25 are arranged between the two retaining jaws pairs 18, 18′ and 19, 19′, with respect to the x-axis. The retaining device comprising the retaining jaws can preferably already be in a position, during threading, in which they no longer hold the cable. Since the force brought about by the springs 34 can be comparatively small, it is, however, also conceivable that the clamping action of the cable 21 by the retaining jaws 18, 18′; 19, 19′; 23, 23′; 24, 24′ is not overcome. The drive of the drive rollers 25 can be sufficiently strong that the cable 21 can still be moved even in the event of contact of the retaining jaws.

In order to grasp the cable more reliably, the cable receiving module 10 has roller insertion openings 44, which are designed such that they allow the drive rollers of the cable processing machine to be retracted without the cable being able to evade them.

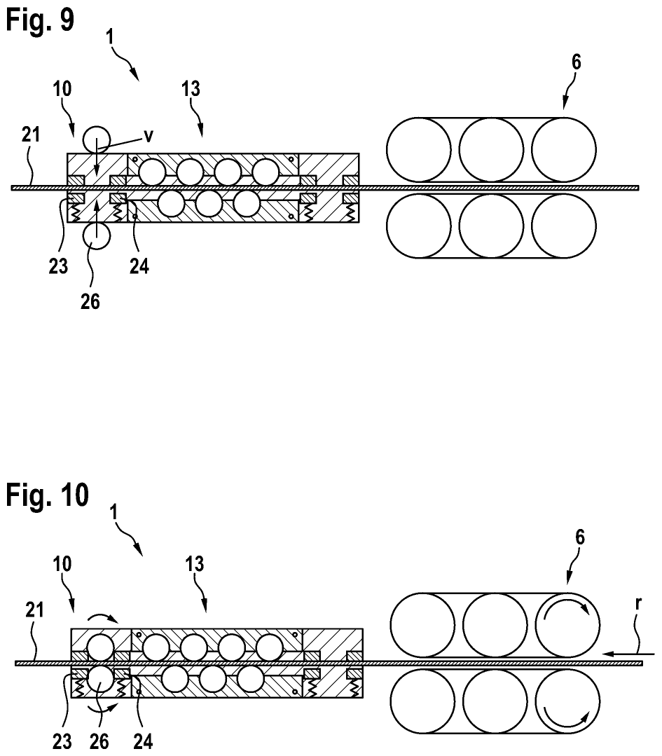

If the cable processing machine 1 has ended the processing of the cable material, a clamped cable, which is no longer required, can be unthreaded again. For this purpose, the cable processing machine 1 and/or the cable receiving module 10 comprises means with which the cable can be pulled backwards into the cable receiving module 10 in order to prevent uncontrolled loop formation between the cable conveying unit and cable receiving module if the conveying unit were to push the cable backwards. The way in which an unthreading process can be carried out is visible from FIGS. 9 and 10. The cable processing machine 1 comprises rear drive rollers 26 that can be driven by means of a drive, the drive rollers 26 being designed to convey the cable 21, clamped between two drive rollers 26, in the opposite direction to the main transport direction (arrow r), whereby the cable can be conveyed out of the conveying unit 6. Undesired loop formation can be prevented by the pulling movement on the cable 21. The two drive rollers 26 are moved from the rest position, shown in FIG. 9 and indicated by the arrows v, into an active position, and enter the cable connection module 10, so that the two drive rollers 26 contact the cable 21 located in the cable connection module 10 in a clamping manner in the active position. The drive rollers 26 can now convey the cable 21 backwards in the r direction. This is shown in FIG. 10. As soon as the cable start of the cable 21 leaves the conveying unit 6, the unthreading process is completed. The cable connection module 10 can be released and removed from the cable processing machine 1, the drive rollers 26 being previously moved back again, and the retaining device with the retaining jaws 18, 18′; 19, 19′; 23, 23′; 24, 24′ preferably being brought into a position in which they act on the cable 21 in a clamping manner for fixing.

During the unthreading, the conveying unit 6 can also be driven in a backward direction at a speed which is not greater than that of the drive rollers 26 in question.

A further advantageous embodiment can result if the drive rollers 26 touch the cable 21 only during the unthreading or if the drive rollers 26 also are or remain together during production, in order to stretch the cable 21 during the forward transport with an opposite torque upstream of the straightening apparatus, which results in a particularly precise straightening effect, because the cable 21 is tensioned with a defined force against the straightening rollers 16, 17.

Both drive rollers can be actively driven, per pair, by the corresponding drive rollers 25, 26. However, it is also possible for only one of the two drive rollers to be driven, and the other of the two drive rollers is fastened in the support so as to be freely rotatable and is driven passively via the other drive roller.

The introduction of the cable start into the conveying unit can be supported by the device shown with the drive rollers 25, 26, which pushes the cable 21 out of the cable receiving module 10 into the conveying unit 6. As in the embodiment according to FIGS. 7 to 10, these drive rollers 25, 26 can be part of the cable processing machine 1 or alternatively (not shown) of the cable-receiving module 10. According to the embodiment mentioned, the device can consist of two drive roller pairs belonging to the cable processing machine 1, which are retracted into the cable receiving module. However, it is also conceivable to use only one drive roller pair.

The method for connecting a cable 21 to the arrangement for assembling cables substantially comprises the following steps:
1. Attaching the mobile cable connection module 10 to the cable 21 in the region of the cable end or at the start of the cable, and
2. Transporting the cable 21, together with the cable connection module 10 attached thereto, transferring the cable end or the cable start, together with the cable connection module 10 attached thereto, for arrangement and fastening of the cable connection module 10 to the cable processing machine 1 of the arrangement, whereby the cable 21 is connected, the cable connection module being in a parked position or already in a working position after the connection.

In this case, the transfer can take place manually or automatically using a robot or another transfer device.

Until transport or until connection, the cable 21 is preferably held in cable connection module 10 in such a way that it projects out of the cable connection module 10 (see for example FIGS. 2 and 4).

FIG. 11 relates to a variant of a mobile cable connection module 10, which substantially differs from the cable connection module 10 according to FIG. 2 only in that it is equipped with a machine-readable identification 40. Thanks to the machine-readable identification 40, before, during or after the connection, the arrangement with the cable processing machine 1 can be identified by means of a reading device with regard to precisely what sort of cable 21 it is.

The cable receiving module 10 can be equipped with an identification and, in particular, with an identification carrier with or without data memory—for example an optical code (barcode, QR code, etc.) or an RFID tag—which can be read out on the machine by a reading device or by a person.

The cable straightening unit 13 of the cable receiving module 10 comprises the two roller supports 37, 38, of which preferably at least one is movable in the plane perpendicular to the roller axes. The roller support 37 is held in the open position by springs, for example. In this open position, the straightening rollers are located at a distance at which the cable can be pushed through or inserted without any problem and is preferably not curved by the straightening rollers.

After the cable receiving module 10 is in the working position, the cable processing machine 1 can move the roller supports 37, 38 relative to one another into the correct position in order to achieve an optimal straightening effect.

FIGS. 12 and 13 relate to a variant of a cable processing machine 1, which has a single slot for the cable connection module 10. When the cable connection module 10 is connected to the cable processing machine 1, the cable held by it is aligned coaxially with the machine longitudinal axis 20 and is already in a working position (FIG. 13). Furthermore, it can be seen from FIG. 12 that the cable processing machine 1 comprises actuators 32, with the aid of which the receiving mandrels 28 can be moved. Thanks to the receiving mandrels 28 that are moved in this way, the cable straightening unit 13 can be adjusted so that it is closed and pivoted, as shown in FIG. 13. The fixedly arranged or immovable receiving mandrels are denoted by 28′.

One possible embodiment for this is that the two receiving mandrels 28, which are movable by actuators 32, for the movable roller support 37 enable the roller support 37 to be acted upon with desired forces (e.g. pneumatic cylinders) or positions (e.g. motor drive) in a plane perpendicular to the roller axes. For example, the right-hand receiving mandrel 28 is set in such a way that the two opposite output-side straightening rollers 16, 17 already touch the cable 21, while the left-hand receiving mandrel 28 is acted upon with force against the cable 21 in such a way that a desired straightening strength is achieved.

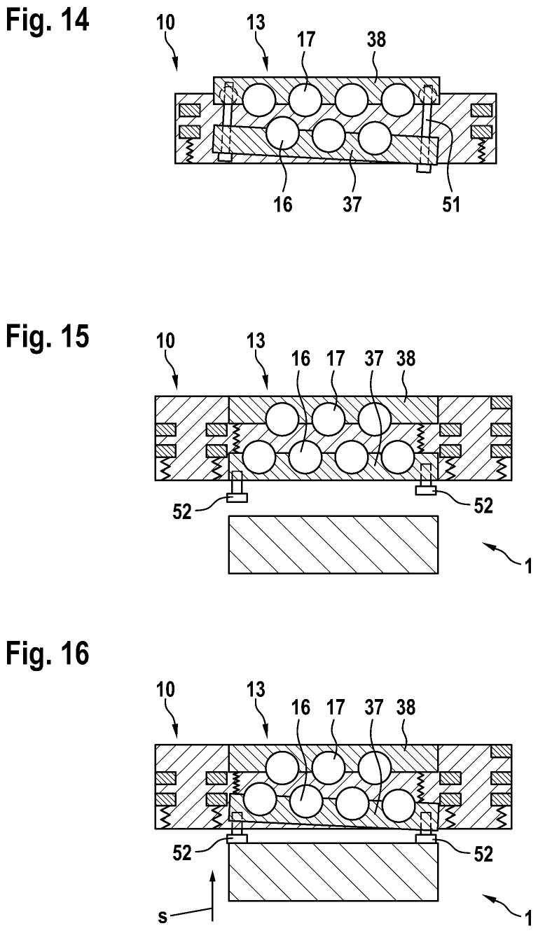

However, variants of cable connection modules 10 are also conceivable in which the straightening function, for straightening the cable, is achieved in another way. For example, FIG. 14 shows a mobile cable connection module 10 having a manual adjustment option of the cable straightening unit 13. By means of adjusting screws 51, the roller support 37 of the cable straightening unit 13 can be moved for closing and brought into the oblique orientation shown in FIG. 14. In FIG. 14, the mobile cable connection module 10 is shown without a cable. It can be advantageous to introduce the cable into the cable connection module 10 and to attach the cable connection module 10 to the cable and to adjust the cable straightening unit 13 at any location, in particular, before the cable connection module 10 is connected to the cable processing machine 1. A special feature of this embodiment of the straightening unit 13 is therefore that the two roller supports 37, 38 are set on the cable receiving module 10 in a manner fixed relative to one another, for example with the two adjusting screws 51.

The adjustment of the roller support 37 or, if applicable, both roller supports, can take place manually or using an automatic or semi-automatic adjusting device at a set-up station or directly on the cable processing machine, for example by the setting of the two adjusting screws 51 taking place manually or an automatic adjusting device being coupled to these adjusting screws 51 and turning them until the cable straightening unit is in the correct position.

Furthermore, the cable straightening unit 13 of the cable connection module 10 can be designed in such a way that the roller supports 37, 38 do not have any adjustment possibility, but rather are optimized for certain cable types. Such a design can be implemented particularly cost-effectively by the omission of movable parts.

A semi-automatic variant is shown in FIGS. 15 and 16. The cable straightening unit 13 of the mobile cable connection module 10 has means for presetting the closed and inclined position. By means of presetting screws 52, which, as shown in FIG. 15, clearly project at different distances from the roller support 37, the desired position can be preset. After the connection, it is only necessary to move a simple actuator, associated with the cable processing machine 1, with a stop in the form of a punch-like plunger, in the s direction, which pushes away the roller support 37 and brings it into the position shown in FIG. 15.

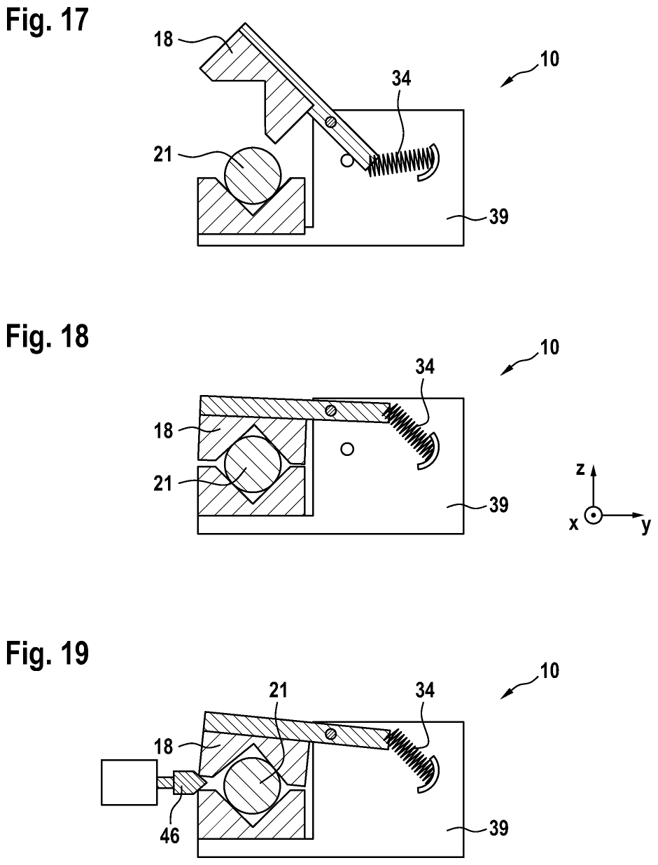

FIGS. 17 to 19 relate to a further embodiment of a mobile cable connection module 10. The cable connection module 10 is characterized by a special retaining device. The clamping force can be generated by tensioned helical compression springs 34. The retaining device can be mechanically coupled to the movement of the roller support 37 in such a way that the retaining device is opened when the roller support 37 is moved together.

The retaining device can, for example, be designed as a bistable mechanism in which the spring 34 remains in the closed or open position without external forces. As a result, the cable 21 can be manually inserted without the retaining device having to be held open against the spring force of the spring 34 during the insertion (FIG. 17). At the end of the insertion process, the retaining device is snapped shut and it holds the cable in the intended position (FIG. 18) by means of a spring force. After the cable receiving module is in the working position, the cable processing machine can release the retaining device by means of a suitable actuator, for example a pneumatic cylinder, which activates a release element 46 so that the cable 21 can be moved and processed (FIG. 19). Analogously, the cable processing machine can close the retaining device again after the cable has been moved back into the starting position and before the cable receiving module is to be moved out of the working position.

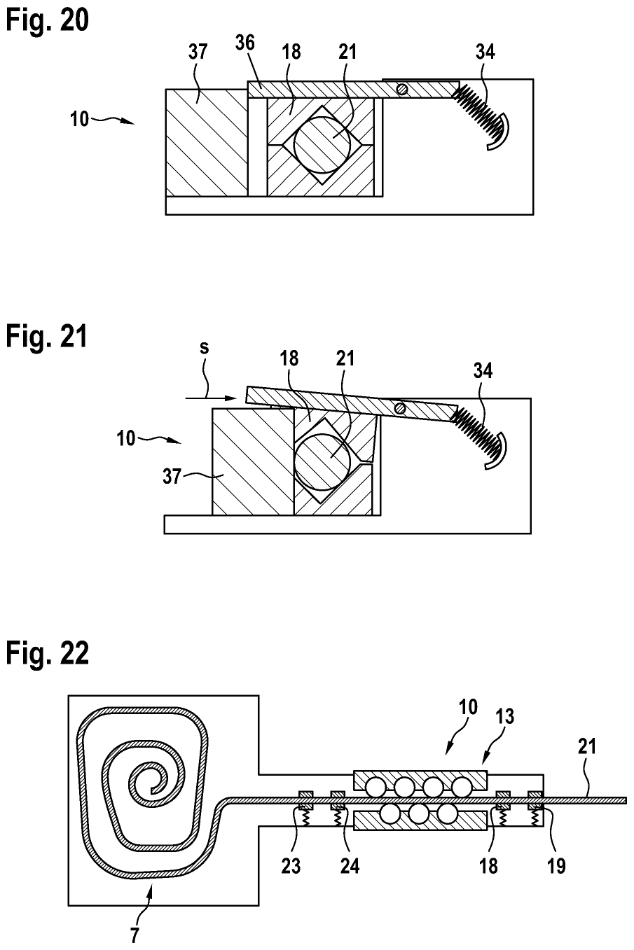

If the roller supports 37, 38 are unintentionally pressed together, for example when the cable receiving module 10 is held in the hand during transport and accidentally pressed together, there is a risk that the cable 21 is pulled inwards due to the extended path along the straightening rollers, between the retaining jaws, when the roller support is not tensioned, and thereby no longer lies cleanly between the straightening rollers. In order to prevent this, the cable connection module can be provided with a device that prevents the possibility of the roller supports being unintentionally pressed together. Such a device is shown in FIG. 20.

FIG. 20 shows a mobile cable connection module 10 having a locking element 36 designed in the form of a lug, by means of which the roller supports 37, 38 can be unintentionally pressed together for transporting the cable connection module 10. The retaining devices are provided with the mentioned lug, which lies between the roller supports in the position holding or clamping the cable, so that this undesired movement is blocked. After the connection, this blocking can be overcome, so that the roller support 37 can be moved against the roller support 38 for the purpose of delivery (see FIG. 21). For transport, the cable 21 can consequently be held in the cable connection module 10 in such a way that it is not acted upon by the straightening rollers 16, 17, and that the cable 21 is acted upon by the straightening rollers 16, 17, for straightening the cable, only after the connection.

As shown in FIG. 22, the cable connection module 10 can be connected to the cable bundle 7 and form a mobile unit together therewith. A special feature of this variant of the cable receiving module 10 is that it integrates the function of the cable bundle in that a container of the bundle is molded onto the cable receiving module 10 or fastened in another way, from which container the cable is pulled or into which it is pushed back again. This is particularly feasible for fine cables that require little volume and allow narrow bending radii. This type of cable connection modules 10 can be placed as a whole on bearings and enables very simple and space-saving logistics.

Furthermore, detachable connections between the cable connection module 10 and cable bundle 7 are also conceivable. The cable connection module 10 can accordingly be designed to be connected to the cable bundle 7 before the connection, so that the cable connection module 10 can be stored and transported with the cable bundle 7.

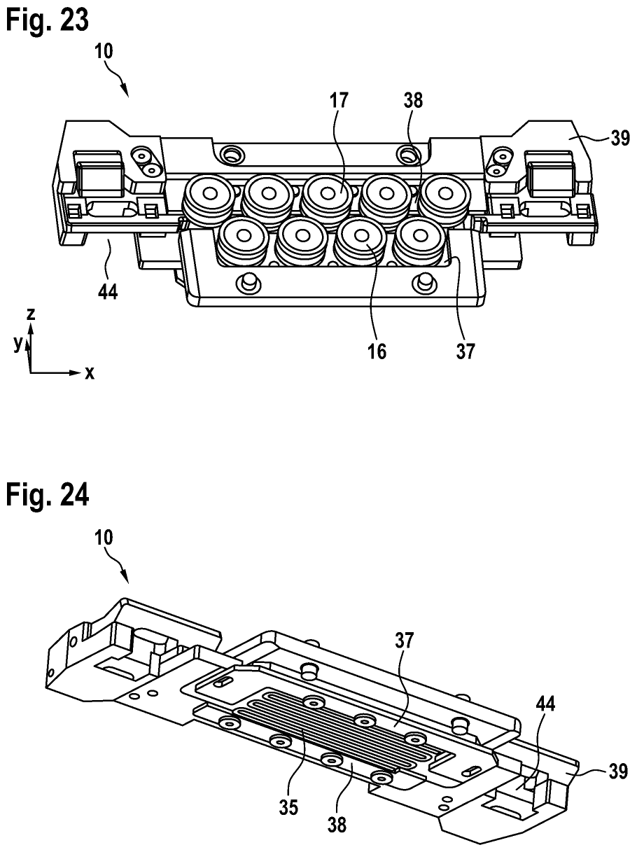

Structural details of a mobile cable connection module 10 are shown in FIGS. 23 and 24. The straightening rollers 16 of the first roller group 14 are fastened to the roller support 37, designed in the manner of a plate, so as to be freely rotatable. The straightening rollers 17 of the second roller group 15 are fastened to the roller support 38, designed in the manner of a plate, so as to be freely rotatable. The module frame 39 in the form of a base plate serves to carry the two roller supports 37, 38. The roller supports 37, 38 are operatively connected in an open position by means of a spring arrangement for generating a preload force for the cable straightening unit 13. In the present case, the roller supports 37, 38 of the cable straightening unit 13 are connected to one another via a spring arrangement denoted by 35 and are formed in one piece. This spring assembly 35 can be seen in FIG. 24. The spring assembly 35 is designed to be flat and can be produced together with the roller supports 37, 38 from a common metal sheet. The spring assembly 35 can be produced by a lasered steel sheet. The spring assembly 35 clearly has a serpentine or meandering structure. For straightening the cable, the roller supports 37, 38 are moved toward one another in a delivery movement.

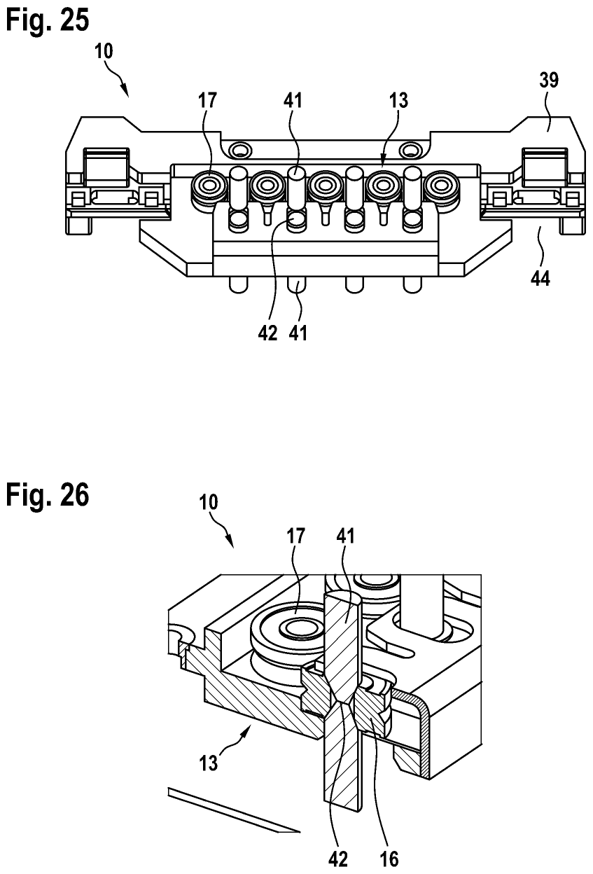

Furthermore, mobile cable connection modules are also conceivable, in which at least some of the straightening rollers are not fastened in the roller supports so as to be freely rotatable. Such an embodiment is shown in FIG. 25. The cable straightening unit 13 of the mobile cable connection module 10 has a roller support 37 for the roller groups 14, in which the respective straightening rollers 16 of the roller group are loosely held. The freely rotatable mounting of the straightening rollers 16 results in that shaft elements 41 are inserted into bearing bushes 42 of the straightening rollers 16 from the direction of the cable processing machine 1. The bearing thus produced for the straightening rollers 16, which are now freely rotatable about the shaft elements 41, can be seen particularly well from the detailed view of FIG. 26.

Some of the rollers (i.e. the straightening rollers 16) can thus also be held loosely in the cable receiving module 10, which is why no actual roller support is then necessary. The cable processing machine 1 can have shafts or shaft elements 41 having conical tips, which are inserted into the holes (formed by the bearing bushes 42) of the straightening rollers 16. The cable processing machine 1 thus fixes the straightening rollers and then brings them, analogously to the previously described roller support, into the intended position. The bearings for the rotation of the straightening rollers 16 can be part of the cable processing machine 1, so that the straightening rollers 16 do not require their own bearings and costs can be saved on the side of the cable receiving module 10.

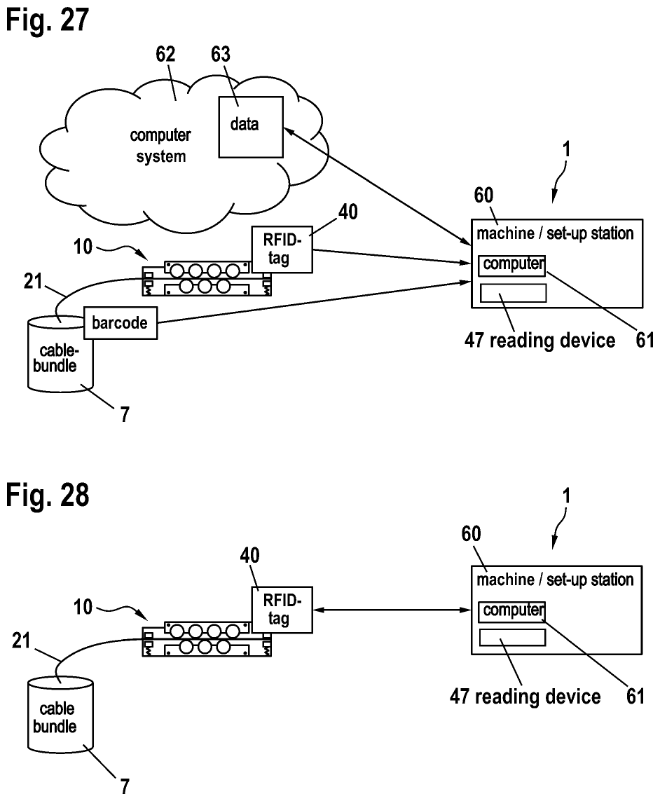

Various advantages result when the cable connection module 10 is equipped with a machine-readable identification 40. FIG. 27 shows an arrangement comprising a reading device 47, which is designed to detect data relating to a cable 21, held by a cable connection module 10. At a workplace 60 for setting up (“set-up station”, for short) of the cable-receiving module 10, identification, properties, adjustment values, processing parameters, and further data of the cable material and the cable receiving module can be written into a computer system 61 or onto the identifier 40, and in particular, to the identification carrier, and the data can be linked and stored. A cable processing machine 1 itself, which has the corresponding devices, can also be used as the set-up station. The person at the set-up station can, for example, read in the identification of the cable bundle by means of a barcode scanner, if, by way of example, a barcode is used, whereupon the computer 61 at the set-up station 60 determines the associated material and process parameters from a higher-level computer system 62. The cable connection module 10 is equipped, by way of example, with an RFID tag 40. After the person has inserted the cable 21 into the cable receiving module 10, they read the identification and further data of the cable receiving module 10 using an RFID reader as a reading device 47, at the set-up station 60. Of course, this step can also take place automatically. As can be seen from FIG. 27, the computer 61 of the set-up station 60 links the data of the cable bundle 7 and cable connection module 10, and stores this in a memory 63 of the higher-level computer system 62 or on the RFID tag 40.

If a cable connection module 10 is connected to the cable processing machine 1, this can obtain the stored data via the RFID tag 40 or identify the cable connection module and obtain linked data via the higher-level computer system 62, derive therefrom relevant process data for controlling the cable processing machine 1 or for traceability of the cable produced, or write back the cable consumption and the remaining cable quantity.

The data storage can also be used merely to write relevant settings, which were most recently performed on the cable processing machine 10 with the cable connection module 10 (for example the last position of the roller support), from the cable processing machine 1, as can be seen from FIG. 28, to the RFID tag 40 of the roller support, or, as shown in FIG. 27, associated via a superordinate computer system 61 of the cable receiving module 10.

An RFID tag 40 attached to the cable receiving module 10 can also be used to locate the cable receiving module 10, so that it can be easily found, or an automatic inventory can be carried out.

From the stored consumption data, the higher-level computer system 62 can also determine the demand for cable material and automatically initiate the order of new cable material or request maintenance of the cable connection module 10 and/or the cable processing machine 1.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A mobile cable connection module for use with an arrangement that assembles cables, the cable connection module comprising:
a retaining device adapted to attach the cable connection module to a cable and to hold the cable;
wherein the cable connection module is adapted to be releasably connected, together with the cable held by the retaining device, to a cable processing machine of the arrangement.

2. The cable connection module according to claim 1 wherein the retaining device includes at least two opposing retaining jaws that clamp the held cable.

3. The cable connection module according to claim 1 including a cable straightening unit that has two roller groups, each of the roller groups having a plurality of straightening rollers, wherein the cable is guided alternately between the straightening rollers of the two roller groups in a transport direction through the cable straightening unit.

4. The cable connection module according to claim 3 wherein the cable straightening unit includes two roller supports each having the straightening rollers of a respective one of the roller groups freely rotatably fastened thereon, and a cable module frame carrying the two roller supports with one of the roller supports being displaceable in a closing direction on the cable module frame, and wherein the cable connection module is detachably connected to the cable processing machine by at least one of the roller supports and/or the cable connection module is detachably connected to the cable processing machine by the cable module frame.

5. The cable connection module according to claim 1 including lateral roller insertion openings formed therein into which drive rollers are retracted in a radial direction of the cable thereby establishing an operative connection whereby the drive rollers drive the cable forward and/or backward in a transport direction of the cable.

6. The cable connection module according to claim 1 wherein the cable connection module adapted to be connected to a cable bundle to store and transport the cable connection module together with the cable bundle.

7. The cable connection module according to claim 1 including a machine-readable identification.

8. An arrangement for assembling cables comprising:
a cable connection module according to claim 1; and
a cable processing machine having at least one processing station, a feed unit including a cable gripper for feeding a cable end of a cable to the at least one processing station, and a connection means that detachably connects with the cable connection module holding the cable.

9. The arrangement according to claim 8 including a cable pretreatment station comprising a cable straightening unit, the cable straightening unit being included in the cable connection module.

10. The arrangement according to claim 8 wherein the connection means includes a connection platform adapted to connect at least two of cable connection module for selective processing of a cable from one of the cable connection modules, the connection platform being movable by an adjusting mechanism to adjust each of the cable connection modules between a working position and a parked position.

11. The arrangement according to claim 8 wherein the cable processing machine includes drive rollers adapted to be driven by a drive, the drive rollers being spaced apart, in an open position, such that the cable connection module is arranged and fastened between the drive rollers to the cable processing machine, and wherein the drive rollers are movable from the open position into an active position where the drive rollers are introduced into the cable connection module to contact and clamp the cable.

12. The arrangement according to claim 11 wherein the drive rollers include a front drive roller pair and a rear drive roller pair, the front drive roller pair adapted to thread the cable into the cable processing machine and the rear drive roller pair adapted to unthread the cable from the cable processing machine.

13. The arrangement according to claim 8 including a reading device that detects data relating to the cable held by the cable connection module.

14. A method for connecting a cable to the arrangement for assembling cables according to claim 8, the method comprising the steps of:
attaching the cable connection module of the arrangement to a cable in a region of a cable end of the cable;
transferring the cable end together with the cable connection module attached thereto to the cable processing machine of the arrangement; and
fastening the cable connection module to the cable processing machine.

15. The method according to claim 14 wherein prior to fastening the cable is held in the cable connection module such an end of the cable projects out of the cable connection module.
